(19) United States
(12) Patent Application Publication
(10) Pub. No.: US 2020/0072308 A1
(43) Pub. Date: Mar. 5, 2020

(54) BRAKE-ACTUATOR FOR A VEHICLE, IN PARTICULAR COMMERCIAL VEHICLE, AND BRAKE SYSTEM THEREWITH

(71) Applicant: WABCO Europe BVBA, Brussels (BE)

(72) Inventors: Tomasz Kocjan, Rybnik (PL); Oktawian Szuberski, Wroclaw (PL); Michal Zbylut, Zawiercie (PL)

(21) Appl. No.: 16/560,120

(22) Filed: Sep. 4, 2019

(30) Foreign Application Priority Data
Sep. 5, 2018 (EP) 18192641

(51) Int. Cl. F16D 65/18; F16H 25/20; F16D 65/38; F16D 66/02; B60T 1/06; B60T 13/74

(52) U.S. Cl. CPC F16D 65/18; F16H 25/20; F16D 65/38; F16D 2121/24; B60T 1/065; B60T 13/741; F16D 66/021

(57) ABSTRACT

A brake actuator (1) for a vehicle includes a housing (5) and a piston (7) movably mounted inside the housing (5) and configured to reciprocate along a stroke axis (S) between a retracted position and an extended position for applying and releasing a braking force to and from a brake mechanism (101) of the vehicle. An electric motor (3) is operatively coupled to the piston (7) and configured to move the piston (7) rod between the retracted and extended positions such as to apply and release the braking force.

### TECHNICAL FIELD

The present disclosure relates to a brake actuator for a vehicle, in particular commercial vehicle.

### BACKGROUND

Brake actuators of the aforementioned type are used to provide a plurality of braking functions for the associated vehicle. One of the required braking functions is a so-called parking brake function, also referred to as hand brake function. In prior art systems, a brake actuator typically comprises a spring brake portion having a very stiff compressed steel spring which is held in a compressed state by elevated pressure in a pressure chamber. When the pressure in the pressure chamber is released, either deliberately or due to a malfunction, the steel spring rapidly decompresses and pushes an associated piston from a retracted position towards an extended position, leading to an application of braking force to a brake mechanism. These prior art systems are in general very useful and have long been established as state of the art solutions in the market. However, due to the high amount of energy stored in the steel springs in the compressed state, a certain safety risk is always involved when the housing inadvertently comes apart. Also, the prior art brake actuators are comparatively heavy and consume a lot of space in the stroke direction of the actuator. Also, it has been observed that a significant amount of compressed air is necessary to provide the pneumatic braking functions for the prior art braking systems. Generation, preparation, storage and transmission of compressed air between a compressor and the actuator is expensive and leaves room for optimization.

In view of the aforementioned, it was an object of the invention to provide an improved brake actuator which overcomes the challenges of the prior art in the best manner possible. In particular, it was an object of the invention to provide an improved brake actuator which has better efficiency in use of resources, weight and size, and which preferably is more cost efficient.

### SUMMARY

The brake actuator according to the invention comprises a housing, a piston that is movably mounted inside the housing and configured to reciprocate along a stroke axis between a retracted position and an extended position for applying and releasing a braking force to and from a brake mechanism of the vehicle, and an electric motor that is operatively coupled to the piston and configured to move the piston rod between the retracted and extended positions such as to apply and release the braking force.

Preferably, the electric motor is coupled to a screw drive, and the screw drive is coupled to the piston and configured to transfer a rotational drive movement of the electric motor into the movement of the piston. A particular advantage of the screw drive is that it can be integrated into the actuator housing while at the same time consuming very little space. Particularly preferred, the screw drive is mounted coaxially inside a rod of the brake piston such that the screw drive does not impact the size of the brake actuator in the stroke direction. The term “screw drive” is understood to encompass spindle gears as well as ball-screw gears and the like.

A particular advantage of providing the actuating force for the brake actuator with an electric motor is that by virtue of a rotating drive shaft of the electric motor, very precise control of the actuator is made possible. An electric motor comprising a rotating drive shaft which supplies a torque to the screw drive is considered to be superior over direct electromagnetic coil actuators which translate an electromagnetic field change into an axial movement, because the latter are more limited in terms of the available stroke length. With a rotating electric motor, the stroke length is in principle not limited. The drive mechanism can perpetually rotate as long as vault supply is provided.

In a further preferred embodiment, the screw drive comprises a rotating element and a nut, wherein the rotating element and the nut are in thread engagement, wherein one of the rotating element or the nut rests against the piston. The rotating element preferably is a spindle or a screw which is supportable in the housing in the direction of the stroke axis, and is rotatable acted upon by the electric motor. The screw drive preferably is a spindle gear or a ball screw gear. Spindle gears are preferred for high-torque motors. Ball screw gears are preferred for use whenever particularly high efficiency is needed for the transfer of torque to the axial force, since the balls interposed between the rotating element and the nut significantly reduce friction and thus allow for the use of a minimized electric motor.

In a further preferred embodiment, the rotating element is rotatable mounted in the housing, and the nut is a running nut that is movably mounted to the rotating element and rests against the piston. By having the nut move the piston instead of the spindle, the amount of moving mass is reduced in the brake actuator which is considered particularly advantageous, particular for use in a moving vehicle.

Preferentially, the piston is slidably supported in the housing, configured to move along the stroke axis and to pivot from the stroke axis within a pre-determined angle. This is understood to mean that the piston has a neutral position in which for example a planar piston head would be perpendicular to the stroke axis, and wherein a rod of the piston would be parallel, in particular coaxial, to the stroke axis. If the piston pivots away from its neutral position, it is allowed to do so within a predetermined angle to account for lateral movements imposed by the externally mounted brake mechanism. A pivotable piston, also referred to as rocking piston, is generally beneficial due to its tolerance to its mechanical misalignments, but is more demanding to control. The electric motor and its coupling to a screw drive ideally complements the pivoting movements of the piston head, since the nut is only required to rest against the piston, regardless of its angular alignment. The piston is preferably configured to pivot in an articulation range of +/−5 to +/−15 degrees.

In a further preferred embodiment, the rotating element comprises a rotational axis that is parallel to, and in particular coaxial with, the stroke axis and the nut is driven along the rotational axis by rotation of the rotating element. Further preferably, the nut comprises an end face that faces the piston and comprises a convexly shaped surface portion. By providing a convexly shaped surface portion, the piston is allowed to scroll along the convexly shaped service portion when moving at an inclination angle within the aforementioned predetermined range to the stroke axis. The convex shape ensures a proper surface contact between the nut and the piston such that force transfer can efficiently take place to provide the braking force needed.

In a first preferred alternative, the convexly shaped portion has a cylindrical shape to facilitate a planar pivoting movement of the piston. Preferably, the cylindrical shape is developed with respect to a cylinder axis that runs perpendicular to the stroke axis. In a second preferred alternative, the convexly shaped portion has a spherical shape to facilitate a three-dimensional pivoting movement of the piston.

Preferably, the piston comprises a correspondingly shaped concave surface portion which accommodates the convexly shaped surface portion of the nut to ensure a proper positioning of the piston and not with respect to one another.

According to a further preferred embodiment, the electric motor is coupled to the screw drive by one of: a toothed gear drive, a belt drive, a chain drive, a planetary gear, a worm gear, or a combination of at least two of the aforementioned. The belt drive preferably is a tooth belt drive.

In a further preferred embodiment, the brake actuator comprises a number of guide elements that are located in the housing, oriented parallel to the rotational axis of the rotating element, and engage the nut to prevent rotation of the nut. In other words, the guide elements are positioned in parallel to the stroke axis of the piston and force the nut to move along the rotating element, i.e. spindle or screw, without own rotation. This improves the efficiency of the force transfer in the direction of the stroke axis. Preferably, the guide elements prevent rotation of the nut in a clockwise direction as well as in the counter clockwise direction.

In a further preferred embodiment, the housing of the brake actuator comprises a first chamber, preferably a pressure chamber, and a second chamber, preferably a non-pressure chamber, wherein the first chamber and the second chamber are sealed against and separated from one another by the piston.

In the non-pressure chamber, preferably there is a return spring which is operatively coupled to the piston and configured to move the piston towards the retracted position.

The first (pressure) chamber preferably comprises a port for connecting the pressure chamber to a pressure source: This enables the brake actuator to be actuated either purely electrically, in a hybrid-mode by using pneumatic and electric actuation force, or exclusively pneumatically. As will be commented on further herein below, this enables specific functions of the brake actuator to be either carried out electrically, pneumatically or pneumatically with electrical assistance (or vice versa).

The brake actuator further preferably comprises at least one of: a check valve communicating with the second (non-pressure) chamber to reduce elevated pressure inside the second (non-pressure) chamber when the piston moves towards the extended position, or a return valve, preferably mounted to the piston, to compensate vacuum building up inside the second (non-pressure) chamber when the piston moves towards the retracted position. In this, an elevated pressure is understood to mean any pressure above atmospheric pressure, whereas vacuum is understood to encompass any pressure below atmospheric pressure.

The brake actuator of the aforementioned type is particularly beneficial in use when the parking brake function is carried out by the electric motor. For reliably providing the parking brake functionality, the brake actuator does not need to be extremely fast. Significant force, however, needs to be transmitted to the braking mechanism to ensure a standstill of the vehicle in all situations. This is where the advantages of the electric motor come into play.

In return, the service brake function may beneficially be provided or assisted by pneumatic pressure in the pressure chamber to take advantage of the high responsiveness of pneumatic actuator systems.

The present disclosure has herein above been described in a first aspect with regard to the brake actuator itself.

In a second aspect, which is at the same time a preferred embodiment of the brake actuator and an inventive aspect of its own, the present disclosure also relates to a brake system of a vehicle, in particular commercial vehicle. The present disclosure solves its object with respect to the brake system that the brake system comprises a brake actuator according to one of the preferred embodiments subscribed herein above, a brake mechanism operatively coupled to the brake actuator, and an electronic control unit operatively coupled to the brake actuator.

Preferably, the electronic control unit is configured to control the brake actuator such that the electric motor actuates the piston when at least one of: a parking brake function or a service brake function is activated.

As mentioned above, the electric motor preferably is exclusively responsible for carrying out the parking brake function. Alternatively, it is preferred if the electric motor is assisted by pneumatic pressure face into the pressure chamber to carry out the parking brake function or the service brake function. In a further preferred alternative, it is the other way around the pneumatic pressure system is assisted by the electric motor to carry out the service brake function (or the parking brake function). In a further preferred alternative, the electric motor is exclusively responsible for carrying out the service brake function. In a further alternative, the electric motor is exclusively responsible for carrying out the parking brake function, whereas the service brake function of the brake actuator is exclusively carried out pneumatically.

In a further preferred embodiment of the brake system, the brake mechanism comprises at least one brake pad that is subject to wear and a wear sensor operatively coupled to the electronic control unit an configured to measure the wear of the brake pad and to provide a single representative of the wear adjustment, wherein the electronic control unit is configured to control the electric motor of the brake actuator such as to adjust at least one of the retracted and extended positions of the piston as a function of the signal representative of the wear measurement.

In a further preferred embodiment, the piston of the brake actuator has a maximum stroke length that is defined by the retracted position and the extended position, and wherein the brake actuator is configured to communicate to the electronic control unit a signal representative of the maximum stroke length. The maximum stroke length will increase with the degree by which the brake pad is worn out. Since the brake pad is becoming thinner and thinner over its life span, the amount of travel necessary until the brake pad reaches its counterpart e.g. a brake disc, increases. Therefore, obtaining a signal directly representative of the maximum stroke length is a reliable indicator for brake pad wear for the vehicle system. This information can be used either individually or in addition to the information provided by a wear sensor to verify the respective results of the other system.

The signal provided is preferably a data value for a number of revolutions of a rotating actuator part, e.g. the drive shaft of the electric motor, the spindle of the screw drive et cetera. Alternatively or additionally, the signal is a data value for a time interval that passes while the piston moves from the retracted position to the extended position. Provided that the electric motor operates at a constant rotational speed, the time that lapses between the two end positions of the actuator is also a reliable indicator for the amount of travel, given that the thread pitch of the screw drive is typically known. Also, the gear racial in between the electric motor and the piston or running nut is also known.

In a further preferred embodiment of the present disclosure, the brake actuator comprises a locking unit that is operatively coupled to the belt drive and configured to switch between a locked position and a release position, wherein in the locked position, the locking unit is configured to prevent backwards rotation of the belt drive. The locking unit preferably comprises a trigger that is configured to pivot between the locked position and the release position, wherein in the locked position, the trigger engages at least one recess or protrusion provided on the belt drive, particularly preferred on the toothed wheel of the belt drive. The recess or protrusion is preferably defined by one or more teeth on the toothed wheel. The trigger is preferably actuated by an electromagnetic actuator to pivot between the locked and the release position.

In order to enable a mechanical release of the locking unit, the brake actuator preferably comprises a latch that is operatively coupled to the trigger and manually accessible, and configured to pivot the trigger from the locked position into the release position. The latch is positioned separately to the electromagnetic actuator and accessible manually, e.g. with a screwdriver or comparable elongate, thin tool or rod.

For a more complete understanding of the present disclosure, the present disclosure will now be described in more detail with reference to the accompanying drawings. The detailed description will illustrate and describe or is considered as a preferred embodiment of the present disclosure. It should of course be understood that various modifications and changes in form or detail could reliably be made without departing from the scope of the present disclosure. It is therefore intended that the invention may not be limited to the exact form and detail shown and described herein, nor to anything less than the whole of the disclose herein. In particular, any references signs in the claims shall not be construed as limiting the scope of the invention. The word “comprising” does not exclude other elements or steps. The word “a” or “an” does not exclude a plurality.

### BRIEF DESCRIPTION OF THE DRAWINGS

In the drawings,

FIG. 1 shows a schematic 3-dimensional view of a brake actuator according to a preferred embodiment;

FIG. 2 shows a schematic planar cross-sectional view of the brake actuator of FIG. 1;

FIG. 3 shows a first schematic detail view of a locking unit of the brake actuator of FIGS. 1 and 2;

FIG. 4 shows a second schematic detail view of a locking unit of the brake actuator of FIGS. 1 and 2;

FIG. 5 shows a third schematic detail view of a locking unit of the brake actuator of FIGS. 1 and 2;

### DETAILED DESCRIPTION OF THE DRAWINGS

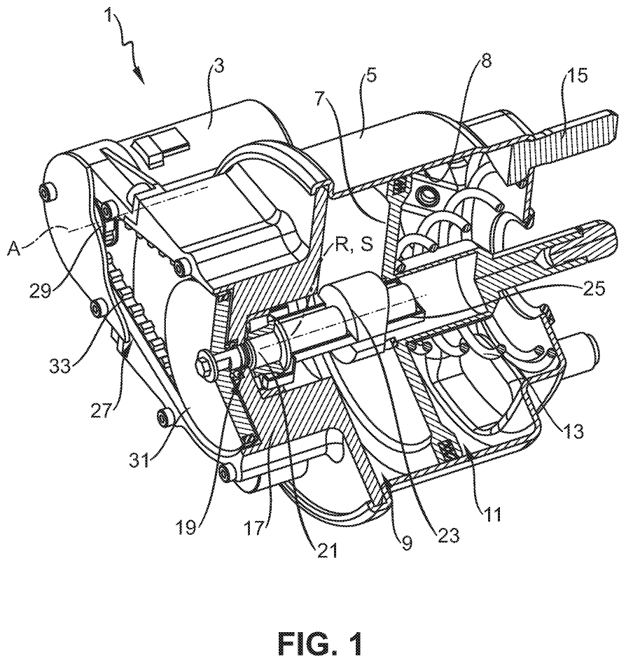

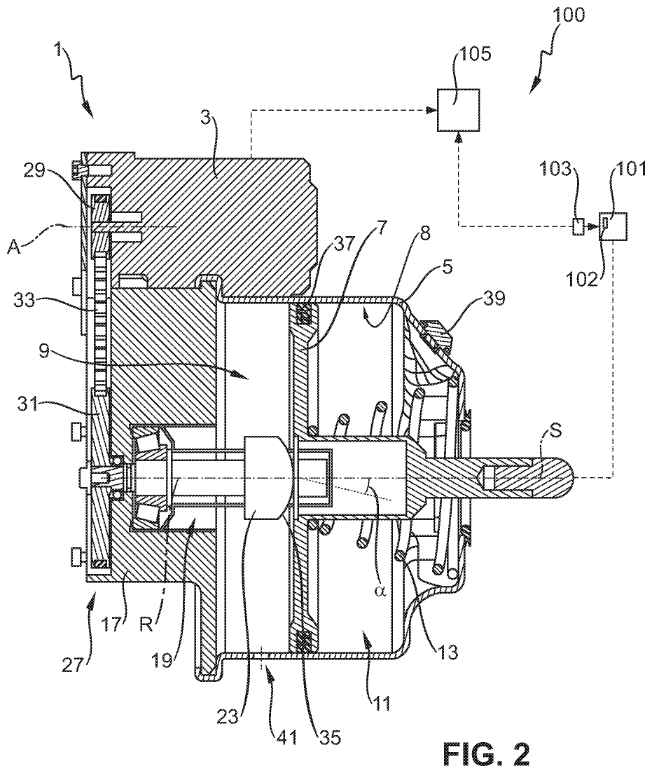

FIGS. 1 and 2 shows a brake actuator 1 in accordance with a preferred embodiment. The brake actuator 1 comprises an electric motor 3 which is attached to a housing 5 and preferably housed integrally therewith. Inside the housing, a piston 7 is mounted for reciprocal movement between a retracted position (to the left in FIGS. 1 and 2) and an extended position (towards the right in FIGS. 1 and 2). The piston 7 sealingly abuts against an inside wall 8 of the housing 5 and separates a first chamber 9 from a second chamber 11.

In the second chamber 11, a return spring 13 is mounted and effective to move the piston 7 towards the retracted position.

The housing 5 of the brake actuator can be mounted to a wheel assembly of a vehicle by using bolts 15 or other suitable fastening elements.

Mounted to the housing 5 is a drive head 17 that houses a screw drive 19. The screw drive 19 comprises a rotatably mounted spindle 21 and a nut 23. The nut 23 and the spindle 21 engage one another with correspondingly shaped male and female threads, respectively. For ease of legibility, the threads are not shown. The nut 23 is prevented from rotational movement by a pair of guide elements 25 aligned in parallel to a rotational axis R of the screw drive 19. The rotational axis R in FIG. 1 is also coaxial to the stroke axis S of the piston 7.

The screw drive 19 is coupled to the electric motor 3 by a belt drive 27. The belt drive 27 comprises a tooth pinion 29 coupled directly to the drive shaft (not shown) of the electric motor 3, a tooth wheel 31 coupled to the spindle 21 and a tooth belt 33 connecting the tooth pinion 29 and the tooth wheel 31. The drive shaft of the electric motor 3 has an axis A that is oriented parallel to the rotation axis R, i.e. stroke axis S of the piston 7. As can be seen from the Figs., the layout of the entire belt drive 27 and screw gear 19 is very compact in the direction of axis R. As can in particular be seen from FIG. 2, the nut 23 comprises an end face 35 having a convexly shaped surface portion 25. The convexly shaped surface portion 25 may be of a cylindrical shape or a spherical shape. The convex shape of the surface portion 25 ensures that even when the piston 7 is pivoted away from the stroke axis at an inclination angle α, proper contact between the nut 23 and the piston 7 is still ensured, as long as the inclination angle is within a pre-determined range.

In the peripheral region of the piston 7, a radially expandable sealing element 37 is positioned such that it sealingly abuts against the inside wall 8 of housing 5. The elasticity of the sealing element 37 preferably is such that as long as the pivoting angle α of the piston 7 with respect to the stroke axis S is within the pre-determined range, the sealing element 37 still sealingly abuts against the sealing wall 8 of the housing 5.

During movement of the piston 7, the volume in particular of the second chamber 11 will decrease or increase, depending on the direction of movement of the piston 7. If the piston 7 is moved towards the extended position (right side in FIG. 2), the volume in the second chamber 11 decreases and elevated pressure may build up. To prevent this from impeding the piston movement, the housing 5 comprises a check valve 39 for venting elevated pressure from the second chamber 11.

In a preferred embodiment, the actuator 1 may additionally comprise a pressure port 41 configured to establish a fluid connection to a pressure source. Doing so turns the first chamber 9 into a pressure chamber. Thus, piston movement may selectively effected electrically, pneumatically or electro-pneumatically. The pressure port is schematically depicted on a sidewall of the brake actuator 1. It is to be understood that the pressure port may alternatively be located on another part of the brake actuator, such as for example on the drive head 17 next to the belt drive 27.

A return valve (not shown) may be integrated into the piston 7. The return valve preferably is configured to compensate vacuum building up in the second (non-pressure) chamber 11 when the piston 7 moves towards the retracted position.

The brake actuator shown in FIGS. 1 and 2 is part of a brake system 100 of a vehicle (not shown). The brake system 100 comprises a brake mechanism 101 which is operatively coupled to the brake actuator and actuated by the piston movement of the piston 7 in the direction of the stroke axis S. The brake mechanism 101 comprises a brake pad 102 which is subject to wear. In one preferred embodiment, the brake system 100 comprises a wear sensor 103 which is configured to monitor the wear status of the brake pad 102 and transmit a signal representative of the wear to an electronic control unit 105. Additionally or alternatively, the brake actuator 1 is configured to determine the maximum stroke of the piston 7 when actuated by the electric motor 3 and to transmit a signal representative of the maximum stroke length to the electronic control unit 105 in accordance with the preferred embodiments described herein above.

The electronic control unit 105 may use either of these signals, if both are present in the embodiment, or just one signal, whichever is present in the respective embodiment, to determine the need for replacement of the brake pad 102. Also, the electronic control unit 105 may adjust the control parameters for the electric motor 3 of the brake actuator 1 to compensate for increasing wear of the brake pad 102, e.g. by adjusting the extended position and retracted position of the piston 7. This way, it can be ensured that the piston 7 is extended far enough in order to create sufficient braking force even with a partially worn out brake pad. Likewise, it is possible to have the piston 7 retract only as far as is needed in view of the wear of the brake pad 7 such that slack between the brake pad and the corresponding counterpart, for example a brake disc, is kept at a minimum.

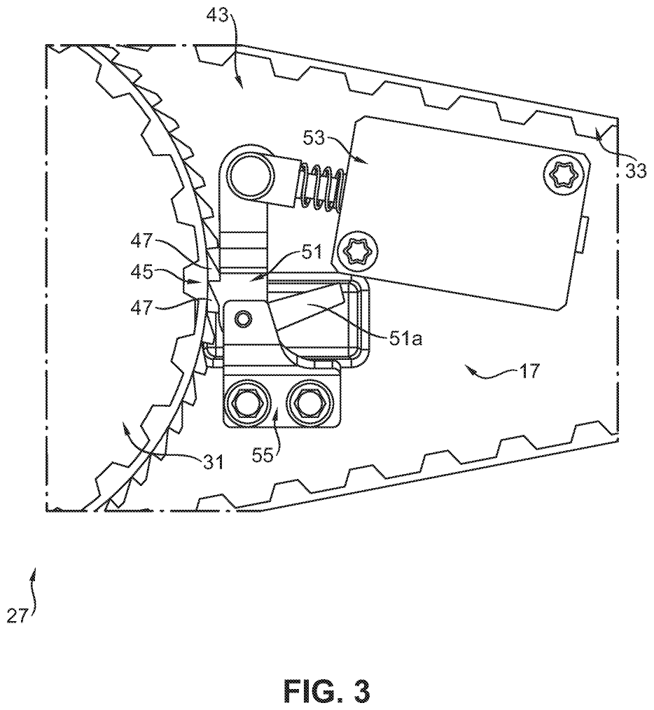

FIGS. 3 to 5 show a locking unit 43 of the brake actuator 1. The tooth wheel 31 has at least one, and preferably a plurality of teeth 47 that are dedicated to providing a locking function for the belt drive 27. This is realized by trigger 51 that is pivotably mounted in the drive head 17 and held by a holder 55. Preferably, the trigger 51 comprises a visible pivot point. The trigger 51 is configured to rotate around the pivot point, and is preferably actuated by an electromagnetic actuator 53. The locking unit 43 prevents an unwanted backward rotation of spindle 21 (see FIG. 2) and tooth wheel 31 after parking force application. The trigger 51 is shown in a locked position in which it engages a recess 45 between two adjacent teeth 47.

When the driver wants to release the parking brake, the electromagnetic actuator 53 is actuated and the trigger 51 is moved from the locked position, preferably in outward direction away from tooth wheel 31, into a release position. Due to the reaction force of the brake and the force of the return spring 13, and particularly due to a non-self-locking thread of the spindle, the piston 7 through the nut 23 (cf. FIG. 2) may rotate the gear in backward direction, until reaching the released position of the piston. This movement can also be (if needed, e.g. to speed up this process) assisted by backward rotation of the electric motor 3.

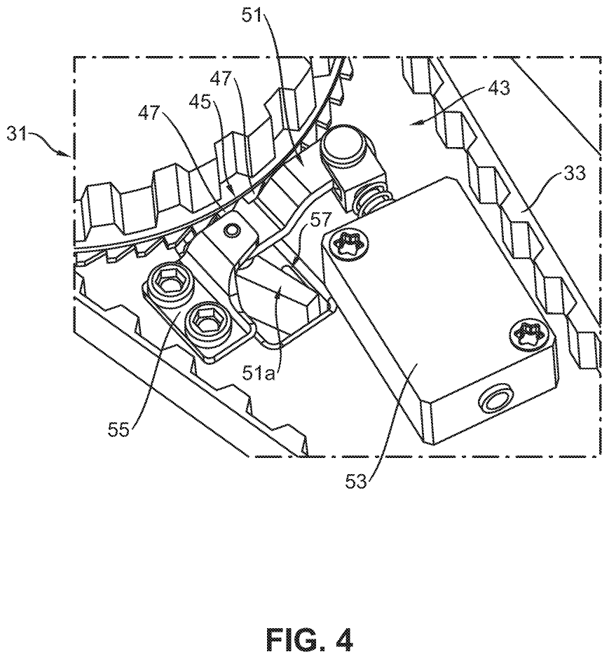

To mechanically release the parking brake, the trigger 51 is equipped with a latch (51a, FIG. 4) which can be pressed-in from the outside of the brake actuator 1 (using e.g. screwdriver or some other thin and long tool or rod) through an access hole 57 communicating with the outside of the drive head 17. This action generates a rotation of the trigger 51 in the same way as it was done by the electromagnetic actuator, but with mechanical (human) force instead of electricity.

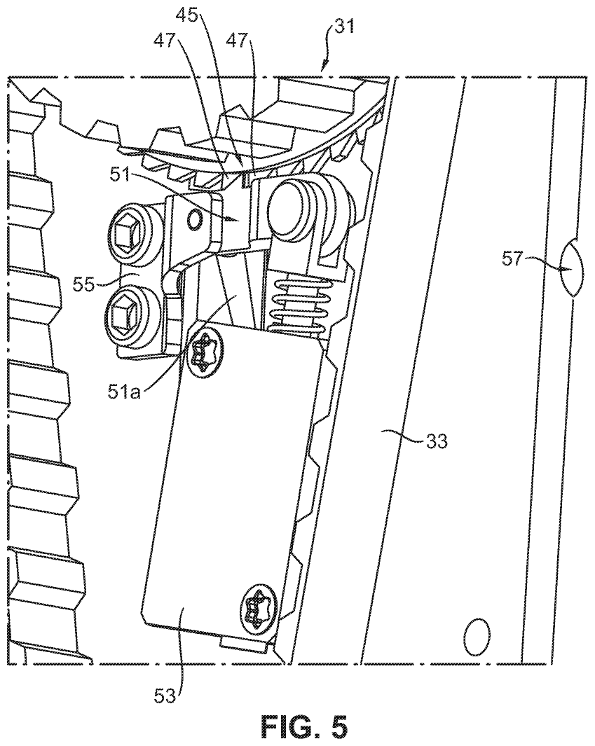

FIG. 5 shows the access hole 57 on the external surface of drive head 17. In regular truck usage this hole should be covered (by e.g. rubber plug) to prevent the contamination ingress into the gear mechanism, and removed if mechanical release action is necessary.

Overall, the Figs. of the preferred embodiment described herein above show a very compact design of an electric brake actuator which can serve multiple purposes, the parking brake function among others.

While the above description constitutes the preferred embodiments of the present invention, it will be appreciated that the invention is susceptible to modification, variation and change without departing from the proper scope and fair meaning of the accompanying claims.

### LIST OF REFERENCE SIGNS (PART OF DESCRIPTION)

1 brake actuator
3 electric motor
5 housing
7 piston
8 inside wall, housing
9 first chamber (pressure chamber)
11 second chamber (non-pressure chamber)
13 return spring
15 bolt
17 drive head
19 screw drive
21 spindle
23 nut
25 guide element
27 belt drive
29 toothed pinion
31 toothed wheel
33 toothed belt
35 end face
37 seal
39 check valve
41 port
43 locking unit
45 recess
47 tooth
51 trigger
51a latch
53 electromagnetic actuator
57 access hole
100 brake system
101 brake mechanism
102 brake pad
103 wear sensor
105 electronic control unit
A rotational axis, electric motor
R rotational axis, screw drive
S stroke axis
α angle

1. A brake actuator (1) for a vehicle, comprising:
a housing (5),
a piston (7) movably mounted inside the housing (5) and configured to reciprocate along a stroke axis (S) between a retracted position and an extended position for applying and releasing a braking force to and from a brake mechanism (101) of the vehicle, and
an electric motor (3) operatively coupled to the piston (7) and configured to move the piston (7) rod between the retracted and extended positions to apply and release the braking force.

2. The brake actuator (1) of claim 1, wherein the piston (7) is slidably supported in the housing (5), configured to move along the stroke axis (S) and to pivot from the stroke axis (S) within a predetermined angle (α).

3. The brake actuator (1) of claim 1, wherein the electric motor (3) is coupled to a screw drive (19), and the screw drive (19) is coupled to the piston (7) and configured to transfer a rotational drive movement of the electric motor (3) into a linear movement of the piston (7).

4. The brake actuator (1) of claim 3, wherein the rotating element (21) comprises a rotational axis (R) parallel to the stroke axis (S) and the nut (23) is driven along the rotational axis (R) by rotation of the rotating element (21).

5. The brake actuator (1) of claim 3, wherein the rotational axis (R) is coaxial with the stroke axis (S)

6. The brake actuator (1) of claim 3, wherein the screw drive (19) comprises a rotating element (21) and a nut (23), wherein the rotating element (21) and the nut (23) are in threaded engagement, wherein the rotating element (21) or the nut (23) rests against the piston (7).

7. The brake actuator (1) of claim 6, wherein the rotating element (21) is rotatably mounted in the housing (5), and the nut (23) is a running nut movably mounted to the rotating element (21) and rests against the piston (7).

8. The brake actuator (1) of claim 6, comprising a number of guide elements (25) that are located in the housing (5), oriented parallel to the rotational axis (R) of the rotating element (21) and engage the nut (23) to prevent rotation of the nut (23).

9. The brake actuator (1) of claim 3, wherein the nut (23) comprises an end face that faces the piston (7) and comprises a convexly shaped surface portion (25).

10. The brake actuator (1) of claim 9,
wherein the convexly shaped portion (25) has a cylindrical shape to facilitate planar pivoting movement of the piston (7), or
wherein the convexly shaped portion (25) has a spherical shape to facilitate three-dimensional pivoting movement of the piston (7).

11. The brake actuator (1) of claim 1, wherein the electric motor (3) is coupled to the screw drive (19) by at least one of:
a toothed gear drive,
a belt drive (27),
a chain drive,
a planetary gear, and
a worm gear.

12. The brake actuator (1) of claim 1, wherein the housing (5) comprises a first chamber (9), preferably a pressure chamber, and a second chamber (11), preferably a non-pressure chamber, wherein the first chamber (9) and the second chamber (11) are sealed against and separated from one another by the piston (7).

13. The brake actuator (1) of claim 12, wherein the first chamber (9) comprises a port (41) for connecting the first chamber (9) to a pressure source.

14. The brake actuator (1) of claim 12, comprising at least one of:
a check valve (39) communicating with the second chamber (11) to reduce elevated pressure inside the second chamber (11) when the piston (7) moves towards the extended position, or
a return valve, preferably mounted to the piston (7), to compensate vacuum building up inside the second chamber (11) when the piston (7) moves towards the retracted position.

15. A brake system (100) of a vehicle, the brake system comprising:
a brake actuator (1) according to claim 1,
a brake mechanism (101) operatively coupled to the brake actuator (1), and
an electronic control unit (105) operatively coupled to the brake actuator (1).

16. The brake system (100) of claim 15, wherein the electronic control unit (105) is configured to control the brake actuator (1) such that the electric motor (3) actuates the piston (7) when at least one of a parking brake function and a service brake function, is activated.

17. The brake system (100) of claim 15, wherein the brake mechanism (101) comprises:
at least one brake pad (102) being subject to wear, and
a wear sensor (103) operatively coupled to the electronic control unit (105) and configured to measure the wear of the brake pad (102) and to provide a signal representative of the wear measurement,
wherein the electronic control unit (105) is configured to control the electric motor (3) of the brake actuator (1) such as to adjust at least one of the retracted and extended positions of the piston (7) as a function of the signal representative of the wear measurement.

18. The brake system (100) of claim 15,
wherein the piston (7) of the brake actuator (1) has a maximum stroke length defined by the retracted position and the extended position, and
wherein the brake actuator (1) is configured to communicate to the electronic control unit (105) a signal representative of the maximum stroke length.
